(19) United States
(12) Patent Application Publication
(10) Pub. No.: US 2023/0330875 A1
(43) Pub. Date: Oct. 19, 2023

(54) BOX CORNER CUTTING TOOL

(71) Applicant: CASCADES CONTAINERBOARD PACKAGING, A DIVISION OF CASCADES CANADA ULC, Québec (CA)

(72) Inventor: Luc LEFEBVRE, Québec (CA)

(21) Appl. No.: 18/041,965

(22) PCT Filed: Aug. 16, 2021
(86) PCT No.: PCT/CA2021/051127

§ 371 Date: Feb. 16, 2023

Related U.S. Application Data
(60) Provisional application No. 63/066,420, filed on Aug. 17, 2020.

(51) Int. Cl. B26B 5/00; B26B 29/06

(52) U.S. Cl. CPC B26B 5/005; B26B 29/06; B25G 1/04

(57) ABSTRACT

A cutting tool for cutting a corner of a cardboard box is provided. The cutting tool includes a guide member having a handle and a guide extending forwardly from the handle. The guide has a pair of guiding wings adapted to engage the cardboard box to position the cutting tool relative to the corner. The cutting tool also includes a cutting element operatively connected to the guide and extending between the guiding wings. The cutting element is adapted to cut the corner of the box via a downward movement of the guide member along the corner of the box. The cutting tool also includes a cut-stopping system connected to the guide member, the cut-stopping system being adapted to contact a working surface, therefore blocking the downward movement of the guide member and limiting the length of the cut.

### TECHNICAL FIELD

The technical field generally relates to cutting tools, and more particularly to a cutting tool adapted to cut the corners of articles, such as cardboard boxes.

### BACKGROUND

Boxes, such as cardboard boxes, can be cut along their corners in order to reduce the height of the box, for example. Grooves can be added to a box to allow flexibility in box height to adapt to the format of the content to be packaged. A user typically uses an X-acto® knife to cut the four corners of the box to the chosen groove and then fold the flaps to the desired height. The corners of the boxes are straight lines which require straight cuts in order to effectively reduce the height of the box without compromising its integrity, for example which could happen if one of the side panels is accidentally cut into.

Furthermore, cutting each corner to the appropriate height can be tedious and time consuming as each corner is preferably required to be cut by substantially the same length.

There is thus a need for a new cutting tool that overcomes at least one of the deficiencies known in the field.

### SUMMARY

According to a first aspect, a cutting tool for cutting a corner of a cardboard box is provided. The cutting tool includes a guide member having a handle and a guide extending forwardly from the handle and comprising a pair of guiding wings adapted to engage the cardboard box to position the cutting tool relative to the corner. The cutting tool also includes a cutting element operatively connected to the guide and extending between the guiding wings, the cutting element being adapted to cut the corner of the box via a downward movement of the guide member along the corner of the box. The cutting tool also has a cut-stopping system connected to the guide member, the cut-stopping system being adapted to contact a working surface, therefore blocking the downward movement of the guide member and limiting the length of the cut.

According to a possible embodiment, the cutting tool further includes a holder removably connected to the guide member, the cutting element being connected to the holder, and wherein connecting the holder to the guide member positions the cutting element between the guiding wings.

According to a possible embodiment, the holder engages the guide member from below via a slot-and-key mechanism.

According to a possible embodiment, the holder includes a base portion and a central portion extending upwardly from the base portion, and wherein the handle of the guide member includes a generally vertical slot shaped and configured to receive the central portion of the holder for connecting the holder to the guide member via the slot and key mechanism.

According to a possible embodiment, the base portion includes clip fasteners adapted to connect to a bottom end of the handle.

According to a possible embodiment, the holder includes a cutting guard extending forwardly from the central portion, the cutting guard being shaped and configured to at least partially surround the cutting element.

According to a possible embodiment, the cutting guard includes a guard tip extending downwardly from a forward end of the cutting guard, the guard tip extending vertically below the cutting element.

According to a possible embodiment, the cutting tool further includes a cutting element casing removably connected to the holder, the casing being configured to hold the cutting element.

According to a possible embodiment, the casing is removably connected to at least one of the central portion and the cutting guard.

According to a possible embodiment, the pair of guiding wings extend from the handle in a manner defining an angle therebetween, each guiding wing comprising a box-engaging surface being shaped and configured to contact a corresponding side of the cardboard box when positioning the cutting tool in the corner.

According to a possible embodiment, the angle is generally 90 degrees.

According to a possible embodiment, the box-engaging surface includes a recess extending along a height thereof, the recess being shaped and sized to be spaced away from the side of the cardboard box during operation of the cutting tool.

According to a possible embodiment, the cut-stopping system includes an adjustable rod having a foot portion adapted to contact the working surface and a rod body extending upwardly from the foot portion, and wherein the guide member is connected to the rod body.

According to a possible embodiment, the rod body includes a plurality of rod sections operably connectable to one another for adjusting a height of the adjustable rod.

According to a possible embodiment, each rod section is threaded and removably connectable to other rod sections.

According to a possible embodiment, the rod body includes a first rod section comprising the foot portion and a second rod section slidably connected to the first rod section for adjusting the height of the adjustable rod.

According to a possible embodiment, one of the first and second rod sections includes a plurality of pin slots disposed along a length thereof, and wherein the other one of the first and second rod sections includes a retractable pin shaped and configured to engage one of the pin slots for setting the height of the adjustable rod.

According to a possible embodiment, the first rod section comprises a pair of retractable pins spaced along a length thereof by a distance allowing only one of the pair of retractable pins to engage the pin slots.

According to a possible embodiment, the cutting tool further includes a stopping mechanism configured to limit the sliding movement of the guide member along the adjustable rod to cut the box along a predetermined length.

According to a possible embodiment, the stopping mechanism includes a protrusion provided along the rod body configured to block downward movement of the guide member.

According to a possible embodiment, the protrusion is a retractable stopping pin, and wherein the stopping mechanism further includes a stopping pin slot provided along the guide member, wherein engagement of the retractable stopping pin within the stopping pin slot blocks further movement of the guide member along the rod body.

According to a possible embodiment, the guiding wings are adapted to maintain the cutting element aligned with the corner of the box during the entire length of the cut.

According to a possible embodiment, the rod body comprises a first rod section and a second rod section operatively coupled to one another, where at least one of the first and second rod section is movable relative to the other one of the first and second rod sections to adjust a length of the rod body.

According to a possible embodiment, the first rod section is adapted to be inserted into the second rod section from below, and wherein the first rod section comprises a retractable pin and the second rod section comprises pin slots shaped and adapted for receiving the retractable pin and secure the first and second rod sections together to define the length of the rod body.

According to a possible embodiment, the guide member comprises a pair of complementary components connectable to one another about the rod body.

According to a possible embodiment, the guide member is removably secured to the second rod section.

According to a possible embodiment, the second rod section is provided with a blocking element along a length thereof, and wherein at least one of the complementary components is provided with a recess shaped and adapted to receive the blocking element when connecting the complementary components together about the rod body, the blocking element being adapted to block movement of the guide member relative to the second rod section when engaged in the recess.

According to a possible embodiment, the blocking element is substantially symmetrical and is adapted to enable positioning the second rod section upside down between the complementary components.

According to a possible embodiment, the blocking element comprises one or more rings secured to the second rod section.

According to a possible embodiment, the second rod section is adapted to be selectively positioned between the complementary components in a manner positioning the pin slots either below the guide member or above the guide member.

According to a possible embodiment, at least one of the complementary components comprises a recessed portion shaped and adapted to receive the cutting element, and wherein the cutting element is secured within the recessed portion upon connecting the complementary components together.

According to a possible embodiment, at least one of the complementary components comprises a cutting guard shaped and configured to at least partially surround the cutting element.

According to a possible embodiment, the complementary components are connectable to one another using at least one mechanical fastener.

According to another aspect, there is provided a cutting tool for cutting a corner of a cardboard box. The cutting tool includes a guide member having a handle comprising an inner chamber and a lower open end; and a guide extending forwardly from the handle and comprising a pair of guiding wings adapted to engage the cardboard box to position the cutting tool relative to the corner; a holder removably insertable through the lower open end to be accommodated within the inner chamber of the handle, the holder comprising an insert region for receiving a blade and a cutting guard extending over the blade while exposing a downward-facing section thereof.

According to another aspect, there is provided a cutting tool for cutting a corner of a box. The cutting tool includes a guide member comprising a pair of complementary components connectable to one another to define a pair of guiding wings adapted to engage the box and position the cutting tool relative to the corner, where connecting the complementary components together defines and internal chamber therebetween. The cutting tool also includes a cutting element secured and extending between the guiding wings, the cutting element being adapted to cut the corner of the box via a cutting motion of the guide member along the corner of the box; and an adjustable rod. The adjustable rod has a locking mechanism proximate a first end of the adjustable rod and being configured to be secured within the internal chamber to prevent movement of the guide member relative to the adjustable rod; and a cut-stopping system proximate a second end of the adjustable rod and being adapted to come into contact with a contact surface and block the cutting motion of the guide member.

According to another aspect, there is provided a cutting tool for cutting a corner of a box. The cutting tool includes a guide member comprising a pair of complementary components connectable to one another to define a guide adapted to engage the box and position the cutting tool relative to the corner, where connecting the complementary components together defines and internal chamber therebetween. The cutting tool also includes a cutting element secured and extending between the guiding wings, the cutting element being adapted to cut the corner of the box via a cutting motion of the guide member along the corner of the box; and an adjustable rod. The adjustable rod has a first rod section comprising a cut-stopping system adapted to come into contact with a contact surface and block the cutting motion of the guide member, and a second rod section comprising a locking mechanism configured to be secured within the internal chamber to prevent movement of the guide member relative to the adjustable rod, where the first and second rod sections are slidably connectable and selectively securable to one another to define a length of the adjustable rod.

According to another aspect, there is provided a cutting tool for cutting a corner of a box. The cutting tool includes a guide member comprising a pair of complementary components connectable to one another to define a guide adapted to engage the box and position the cutting tool relative to the corner, where connecting the complementary components together defines and internal chamber therebetween. The cutting tool further includes a cutting element secured and extending between the guiding wings, the cutting element being adapted to cut the corner of the box via a cutting motion of the guide member along the corner of the box; and an adjustable rod. The adjustable rod has a first rod section comprising a cut-stopping system adapted to come into contact with a contact surface and block the cutting motion of the guide member; and a second rod section comprising a first end at least partially securable within the internal chamber to prevent movement of the guide member relative to the second rod section, and a second end opposite the first end. The second rod section is adapted to be selectively positioned between the complementary components in a manner positioning the second end either below the guide member or above the guide member.

According to a possible embodiment, the first and second rod sections are slidably connectable and selectively securable to one another to define a length of the adjustable rod.

According to a possible embodiment, the first rod section is adapted to engage the end of the second rod section positioned below the guide member.

According to a possible embodiment, the first rod section comprises a retractable pin and the second rod section comprises pin slots shaped and adapted for receiving the retractable pin to at least partially secure the first and second rod sections together to define the length of the rod body.

According to a possible embodiment, the first rod section comprises a pair of retractable pins spaced along a length thereof by a distance allowing only one of the pair of retractable pins to engage the pin slots.

### BRIEF DESCRIPTION OF THE DRAWINGS

FIG. 1 is a perspective view of a cutting tool, according to an embodiment.

FIG. 2 is a perspective view of the cutting tool of FIG. 1 being used to cut a corner of a cardboard box, according to a possible embodiment.

FIG. 3 is a perspective view of a cutting tool according to another embodiment, showing a guide member, a cutting element and a handle.

FIG. 4 is a side elevation view of the cutting tool shown in FIG. 3.

FIGS. 5 and 6 are respectively bottom and top views of the cutting tool shown in FIG. 3, showing guiding wings of the guide member extending on either sides of the cutting element, according to an embodiment.

FIG. 7 is an exploded perspective view of the cutting tool shown in FIG. 3, showing the guide member, the cutting element and a holder, according to an embodiment.

FIG. 8 is a side view of a cutting tool comprising an adjustable rod to control movement of the cutting element, according to an embodiment.

FIG. 9 is a side view of an alternate embodiment of the cutting tool, showing the adjustable rod defining a first height.

FIGS. 10 to 12 are side views of the cutting tool shown in FIG. 9, showing the adjustable rod defining various heights between the cutting element and the bottom of the cutting tool, according to possible embodiments.

FIG. 13 is a perspective view of another embodiment of the cutting tool.

FIG. 14 is an exploded perspective view of the guide member of the cutting tool shown in FIG. 13, showing a pair of complementary components connectable to one another to hold the cutting element therebetween.

FIGS. 15 and 16 are exploded perspective views of the guide member shown in FIG. 14 including the adjustable rod, showing a pair of blockers insertable between the complementary components, according to an embodiment.

FIG. 17 is an exploded perspective view of the guide member shown in FIG. 14 including the adjustable rod, showing a single blocker inserted between the complementary components, according to an embodiment.

FIG. 18 is an exploded perspective view of the guide member including the adjustable rod, showing the adjustable rod in a first configuration where pin slots are positioned below the guide member, according to an embodiment.

FIG. 19 is an exploded perspective view of the guide member including the adjustable rod, showing the adjustable rod in a second configuration where pin slots are positioned above the guide member, according to an embodiment.

FIGS. 20 and 21 are side views of the cutting tool shown in FIG. 13, showing the adjustable rod extending above the guide member and defining various heights between the cutting element and the bottom of the cutting tool, according to possible embodiments.

FIG. 22 is a side view of the cutting tool shown in FIG. 13 without the adjustable rod and defining a height between the cutting element and the bottom of the cutting tool, according to a possible embodiment.

### DETAILED DESCRIPTION

As will be explained below in relation to various embodiments, a cutting tool adapted to cut cardboard boxes is described herein. More particularly, a cutting tool configured to facilitate cutting the corners of cardboard boxes, a method of adjusting a size of the boxes, and related components of the cutting tool are described. The cutting tool of the present disclosure includes a guide member configured to be manipulated by a user when cutting boxes and a cutting element for performing cuts. The guide member can include a handle, along with a cutting guide configured to position the cutting element relative to the box corner when preparing to perform a cut. It is noted that, in order to cut the corner of a box, the cutting element can be positioned vertically above the corner and brought down to cut said corner. The cutting guide is shaped and configured to maintain the cutting element aligned with the corner during the cut. As such, the cutting guide enables quick and assured movements of the cutting element along the corner of the box to perform the desired cuts.

The cutting tool also includes a cut-stopping system, or “stopper”, configured to cooperate with the guide member to stop the cutting motion, and thus stop the cutting element along the corner of the box, such as at a desired height. Therefore, the cut-stopping system allows for cuts of predetermined lengths to be performed and leaving uncut portions of predetermined heights. In combination with the cutting guide, the cut-stopping system enables cuts to be made in a simpler, easier, faster, more accurate, more effective, more functional, more reliable and/or more versatile manner than what is possible with other conventional devices.

Furthermore, although the various exemplary embodiments described herein may be used in relation with a boxcutter, for example, it is understood that it may be used with other types of cutting tools and/or for other purposes. For this reason, the terms “cutter”, “cutting tool” and “boxcutter” as used herein should not be taken as to limit the scope of the present disclosure as being used with a cutting tool for cutting cardboard boxes in particular. It should be understood that the term “cutter” or “cutting tool” should, in the context of the present disclosure, encompass all other types of cutting tools with which the described embodiments could be used and may be useful.

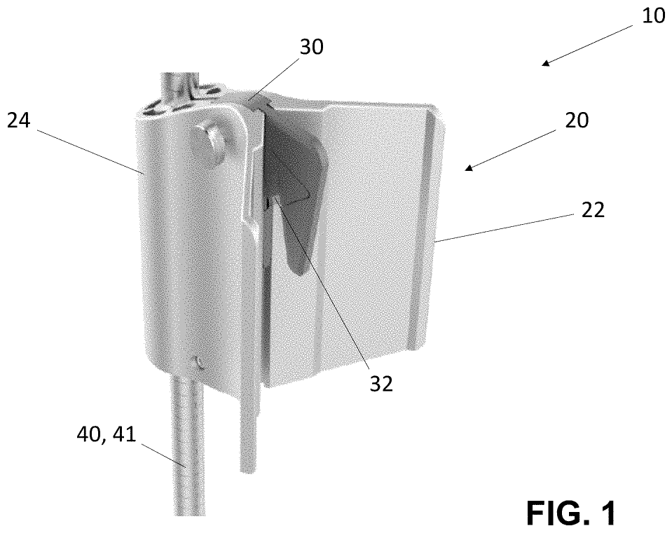

Referring to FIG. 1, an embodiment of a cutting tool 10 is shown. The cutting tool 10 includes a guide member 20 having a guide 22 and a handle 24 to effectively hold and manipulate the cutting tool 10. The cutting tool 10 further includes a holder 30 connected (e.g., secured thereto or removably connected) to the guide member 20 and having a cutting element 32 configured to cut various articles. As will be described below, in some embodiments, the cutting tool 10 includes an adjustable rod 41 cooperating with the guide member 20 for performing cutting operations in a more reliable, fast and accurate manner.

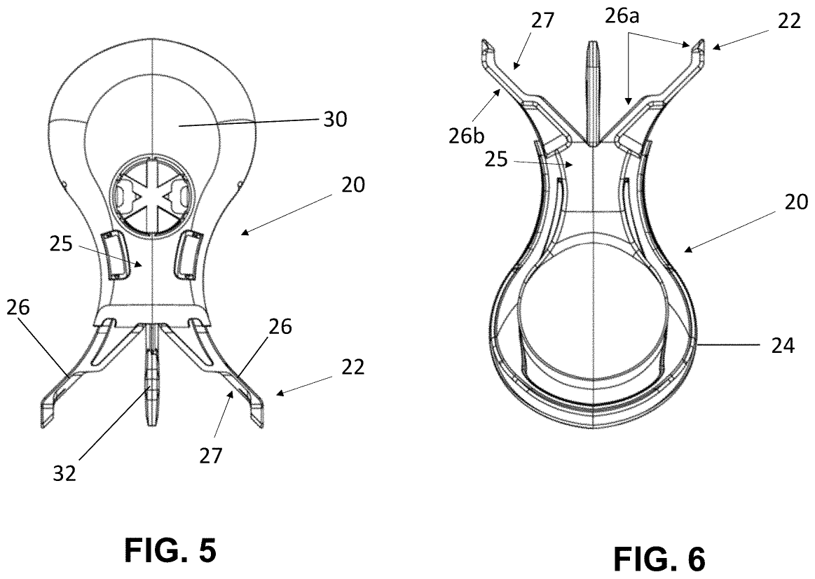

Now referring to FIGS. 1 to 6, the cutting tool 10 may be configured to be positioned at a corner of a cardboard box, for example, with the guide 22 engaging one or more sides of the box in order to align the cutting element 32 with the corner. The cutting tool 10 can then be manipulated to cut the corner of the box as the guide 22 maintains the cutting element 32 aligned with the corner. The guide 22 of the guide member 20 is shaped and sized to abut against one or more sides of a box. In this embodiment, the guide 22 includes guiding wings 26 extending forwardly from the handle 24 in a manner creating an opening or corner-receiving region between the guiding wings 26. In other words, and as seen in FIGS. 5 and 6, the guide 22 includes a pair of guiding wings 26 extending from the handle 24 opposite one another to define an angle therebetween. Preferably, the angle defined by the guiding wings 26 is substantially 90 degrees for allowing the guide 22 (e.g., the guiding wings 26) to engage a 90-degree corner of a box. More specifically, the angle defined between the pair of guiding wings 26 is generally 90 degrees, whereas the angle defined between the cutting element and each one of the guiding wings 26 is generally 45 degrees, although other configurations are possible and may be used. It is appreciated that each guiding wing 26 is configured to engage (e.g., contact) a corresponding side panel of the box extending from a given corner. In some embodiments, the guiding wings 26 can extend forwardly by any suitable length in order to effectively contact the sides of the box for maintaining the cutting element 32 aligned with the corner.

The guiding wings 26 may have plate-like structures, with one plate engaging a first side of the box corner, and the other plate engage a second side of the same corner. In some embodiments, and as seen in FIGS. 5 and 6 for example, each guiding wing 26 includes an inner surface, or box-engaging surface 26a, and an outer surface 26b. In addition, the guiding wings can be provided with a recess 27 extending along a vertical length of the guiding wings and defining a proximal portion 28a proximate the handle 24 (i.e., on a first side of the recess 27), and a distal portion 28b on a second side of the recess 27. In this embodiment, the box-engaging surface 26a is substantially planar across the proximal and distal portions (i.e., the inner surface of the proximal portion is co-planar with the inner surface of the distal portion).

Still referring to FIGS. 1 to 6, the handle 24 can be ergonomically shaped and configured to conform to the grasp of a user. For example, the handle can have a substantially cylindrical shape to facilitate grabbing the cutting tool 10. However, it is appreciated that any other shape and configuration are possible and may be used. In this embodiment, the handle 24 and the guiding wings 26 are formed as a one-piece unit, although other configurations are possible. For example, the guiding wings 26 can be removably connected to the handle portion 24 of the guide member 20, thereby enabling interchangeability of the guiding wings 26 (e.g., for varying the length, the angle, or a combination thereof). As seen in FIG. 5, the guide member 20 can be shaped to facilitate grasping, with the handle 24 having a front section 25 being inwardly curved (or concave) such that the handle 24 can be held, with the fingers grasping the curved front section 25.

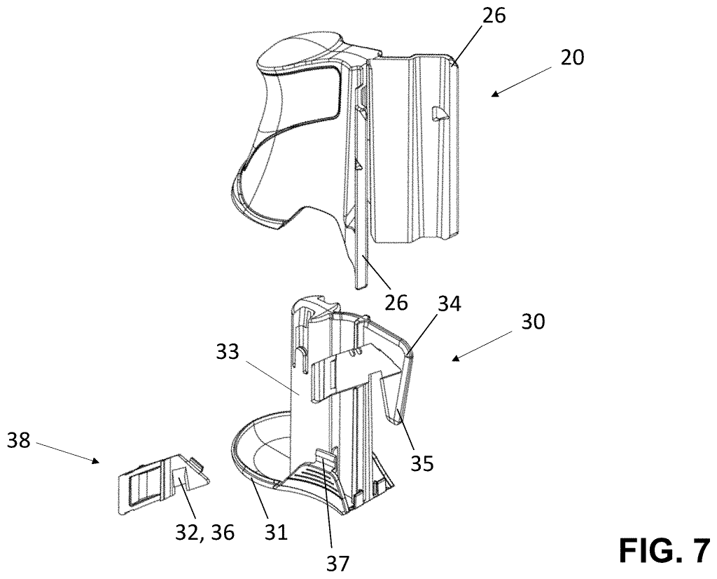

Now referring to FIG. 7, in addition to FIGS. 1 to 6, the holder 30 for holding a sharp cutting element can be connected to the guide member 20. More particularly, the holder 30 includes a base portion 31 and a central portion 33 shaped and configured to engage the guide member 20, whereby the central portion 33 effectively holds the cutting element 32 in a predetermined position. In this embodiment, the central portion 33 extends upwardly from the base portion 31 and is adapted to engage the guide member 20 via a slot-and-key mechanism, with the guide member 20 providing the slot into which the central portion 33 can slide for connecting the holder 30 to the guide member 20. The slot (not shown here) can be defined in the handle 24, for example, although other configurations are possible. It should thus be noted that the holder 30, and therefore the cutting element 32, can be removably connected to the guide member 20. As such, the cutting element 32 can be removed, replaced, repaired, etc., as required. In some embodiments, the base portion 31 can be adapted to further connect the holder 30 to the guide member 20. For example, the base portion 31 can be provided with clips 37, or any other suitable fastener, configured to attach to the handle 24 when the holder 30 engages the guide member 20 (e.g., when the central portion 33 engages the slot within the guide member 20). In this embodiment, the holder base portion 31 and central portion 33 are made as a one-piece unit, although it is appreciated that they could be made as separate pieces, and subsequently connected together.

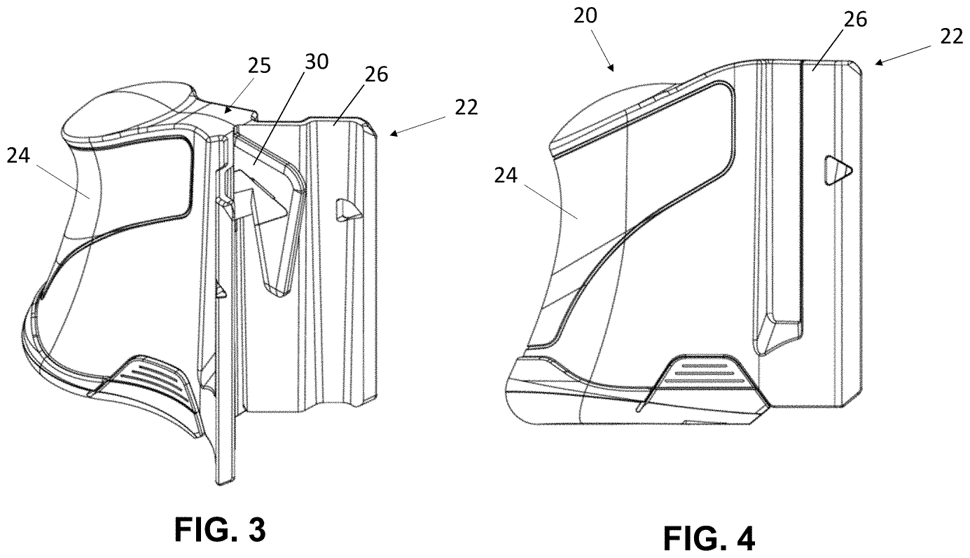

As seen in FIGS. 3 and 7, the holder 30 connects to the guide member 20 in a manner such that the cutting element 32 is positioned between the guiding wings 26. Therefore, it is appreciated that contacting the sides of a box with the guiding wings 26 to position the cutting tool 10 in a corner of a box, effectively positions the cutting element 32 in a predetermined manner relative to the corner. The cutting element 32 can be a blade 36, such as an X-acto® knife or razor blade, or any other suitable blade or cutting element. As previously mentioned, the blade 36 is aligned with the corner of the box via engagement of the guiding wings 26 with the sides of the box. The cutting tool 10 can then slide along a length of the corner (e.g., by moving the cutting tool downwardly) to cut the box along said corner. The holder 30 and the guiding wings 26 can be configured and sized such that the guiding wings 26 include lower portions that extend below the cutting element 32, allowing those lower portions to initially engage with the sides of the box, and then, as the cutting tool 10 is moved downwardly, the cutting element 32 contacts the top of the corner while the guiding wings 26 support and stabilize the displacement.

In some embodiments, the holder 30 can include a cutting guard 34, or protector, designed to prevent unintentional or accidental contact with the cutting element 32, which can be quite sharp. In this embodiment, the cutting guard 34 can extend from the central portion 33 at a top end thereof, and at least partially surrounds the cutting element 32 to prevent accidental contact and injuries. The cutting guard 34 can include a tip 35 extending downwardly at the front of the blade 36 and vertically below the blade 36 to further prevent accidental contact with the cutting element 32 (e.g., to prevent contact with a finger). The cutting guard can cover the entire top, the entire front and the forward part of the bottom of the cutting element, as shown in FIG. 7. Additionally, and as best seen in FIG. 7, the holder 30 can include a removable casing 38 removably connected to the central portion 33. The removable casing 38 can be adapted to house the cutting element 32 (e.g., the blade 36) such that the cutting element 32 can be removed and replaced from the cutting tool 10. The casing 38 can connect to the central portion 33 via a clip, a fastener or any other suitable method. It is appreciated that the casing 38 allows for the blade to be changed out, for example, when too dull, or for security reasons. Alternatively, or additionally, the blade 36 can be removably installed within the casing 38.

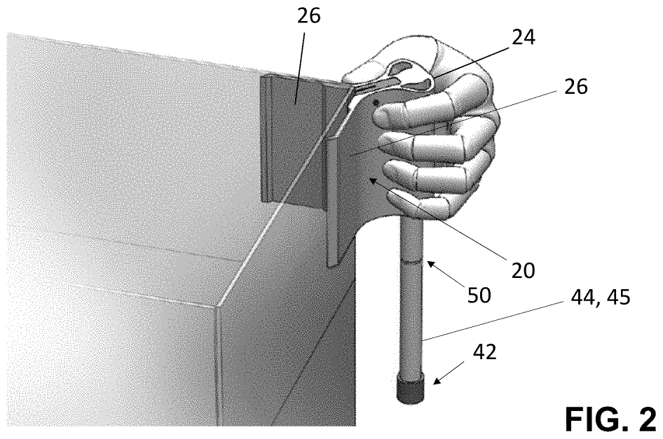

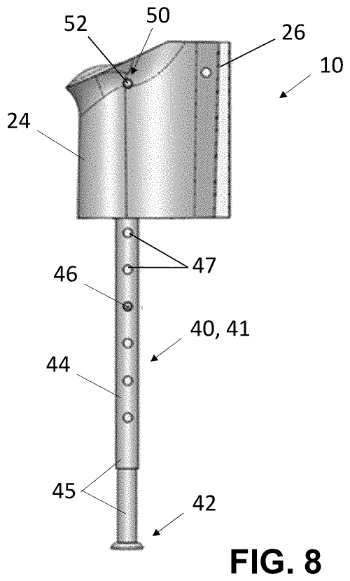

In some embodiments, the cutting tool 10 includes a cut-stopping system 40 configured to effectively control the length at which the cutting element 32 cuts the corner of the box. More specifically, in some embodiments, the cut-stopping system 40 is configured to block movement of the cutting element 32 at a predetermined location along the corner of the cardboard box. Therefore, the cutting tool 10 can be reliably operated to cut the four corners of the box by substantially the same length. In this embodiment, the cut-stopping system 40 includes an adjustable rod 41. With reference to FIG. 8, in addition to FIGS. 1 and 2, the guide member 20 and/or the holder 30 can be connected to the adjustable rod 41 such that a bottom portion of the adjustable rod 41 contacts a working surface (e.g., table, desk, ground, etc.) to stop the cutting element at a desired height when cutting a corner. In this embodiment, the adjustable rod 41 includes a foot portion 42 adapted to contact a ground surface when operating the cutting tool 10, and a rod body 44 extending upwardly from the foot portion 42 along which the guide member 20 can be connected to perform cuts with the cutting element 32. The foot portion 42 can be provided with anti-slip material, such as rubber for example, to prevent the cutting tool 10 from slipping during use.

In the illustrated embodiment of FIG. 8, the rod body 44 includes two or more rod sections 45 telescopically connected to one another. A first rod section 45a can be provided with a retractable pin 46 (e.g., a spring clip) configured to engage pin slots 47 provided along a second rod section 45b, for example. Therefore, it is understood that the length of the rod body 44 can be selected by having the retractable pin 46 engage any one of the given pin slots 47. It should also be appreciated that additional rod sections 45 (e.g., more than two) can be provided to further extend the length of the rod body 44. In this embodiment, a desired rod body length is selected, and then the cutting tool can be used to cut downward along a score line of the corner of a box until the foot portion of the rod hits the working surface, and thus stops the downward movement of the cutting tool at the desired and/or predetermined height. In this embodiment, the upper part of the rod body (e.g., the second rod section 45b) can remain fixedly attached to the handle and/or guide member and the height adjustment is provided by moving the one or more other rod body section(s) (e.g., the first rod section 45a) telescopically with respect to each other and/or the second rod section 45b. In this embodiment, it is noted that the foot portion of the rod is initially spaced away from the working surface and then contacts it once the cut is complete.

It is appreciated that other configurations are possible for forming the rod body 44 of the adjustable rod 41, such as having a plurality of rod sections 45 removably connectable to one another and to the foot portion 42, as seen in FIG. 2. For example, the rod body 44 can include a first rod section 45a having a first length, a second rod section 45b having a second length, where the second length is longer than the first length. The first rod section 45a can be connected to, or include the foot portion 42 for cutting smaller boxes, whereas the second rod section 45b would be used for larger boxes. In addition, the first rod section can be connected to the foot portion 42, and the second rod section can be connected to a top end of the first rod section to further increase the length of the rod body 44. In some embodiments, the rod sections 45 can be threaded at one end to allow another rod section 45, or the foot portion 42, to be connected thereto.

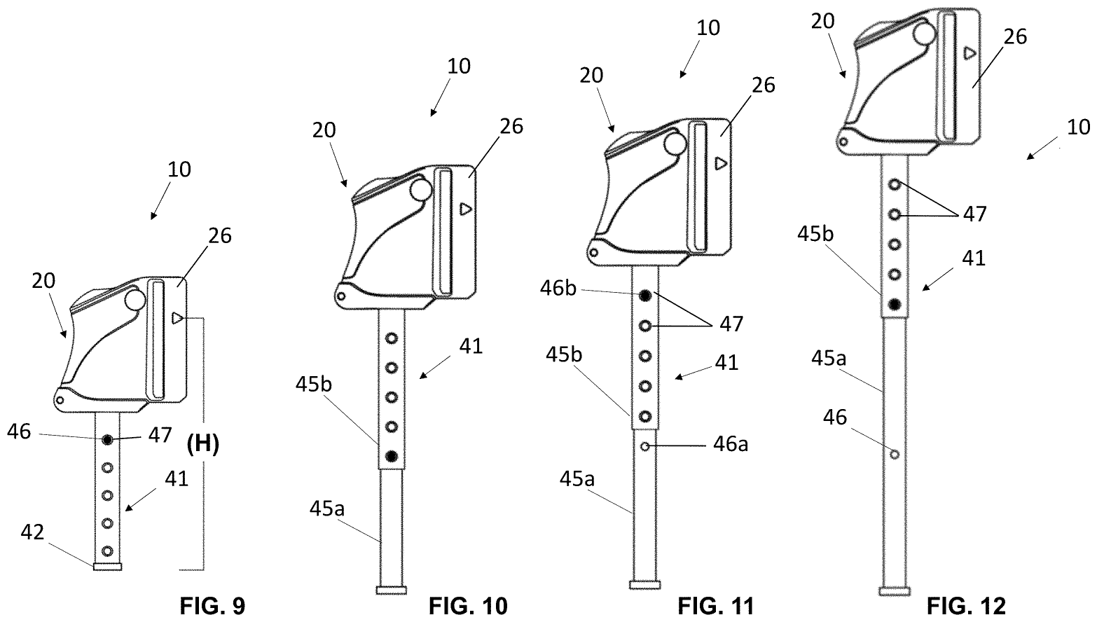

With reference to FIGS. 9 to 12, various configurations of the adjustable rod 41 are shown, where each configuration defines a corresponding height (H) of the cutting tool 10 for creating cuts and defining boxes of desired or predetermined heights. The height defined by the cut can be defined as the distance between the foot portion 42 and the cutting element installed between the guiding wings 26 (e.g., as illustrated in FIG. 9). For instance, the rod 41 can be adjusted to a first height (H), where the first rod section 45a is relatively fully inserted in the second rod section 45b (e.g., where the foot portion 42 abuts the second rod section, as seen in FIG. 9). In some embodiments, this configuration corresponds to the retractable pin 46 engaging the topmost pin slot 47. The first rod section 45a can then be adjusted and incrementally pulled out of the second rod section 45b. For example, the retractable pin 46 can engage each of the subsequent pin slots 47 up to the bottommost pin slot (FIG. 10), which illustratively defines a greater height.

In some embodiments, the first rod section 45a can include one or more retractable pins 46 enabling additional configurations of the adjustable rod 41, such as configurations defining greater heights. As seen in FIG. 11, a first retractable pin 46a can be positioned out of the second rod section 45b and therefore below the pin slots 47, and a second retractable pin 46b engages the topmost pin slot 47. The first rod section 45a can be further adjusted and pulled out of the second rod section 45b until the second retractable pin 46b engages the bottommost pin slot 47 (FIG. 12). In some embodiments, the adjustable rod 41 can be adapted to define heights between about 9 inches (FIG. 9) and about 18 inches (FIG. 12), with intermediate pin slots 47 (e.g., the pin slots between the topmost and bottommost pin slots) being adapted to define any suitable heights between 9 and 18 inches, for example.

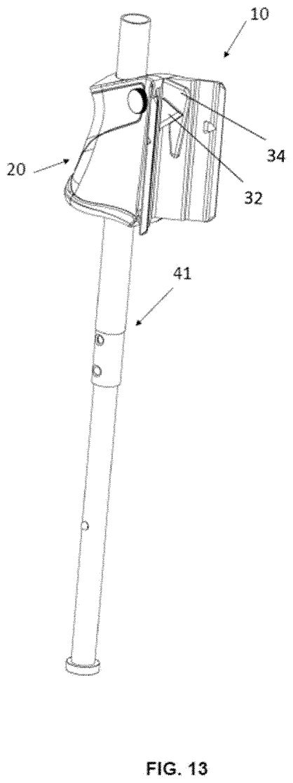

Now referring to FIGS. 13 to 17, another embodiment of the cutting tool 10 is shown. In this embodiment, the guide member 20 includes a pair of complementary components 60 selectively securable to one another about the adjustable rod 41. The complementary components 60 can each correspond to substantially half of the guide member 20 (e.g., half of the handle 24, half of the pair of wings 26, etc.), although other configurations are possible. Connecting the complementary components 60 together can define an internal chamber 63 through which the adjustable rod 41 can extend. In some embodiments, the internal chamber 63 opens on a top side and a bottom side of the guide member 20 such that the adjustable rod 41 can extend through the guide member and have a portion above the guide member, and another portion below the guide member.

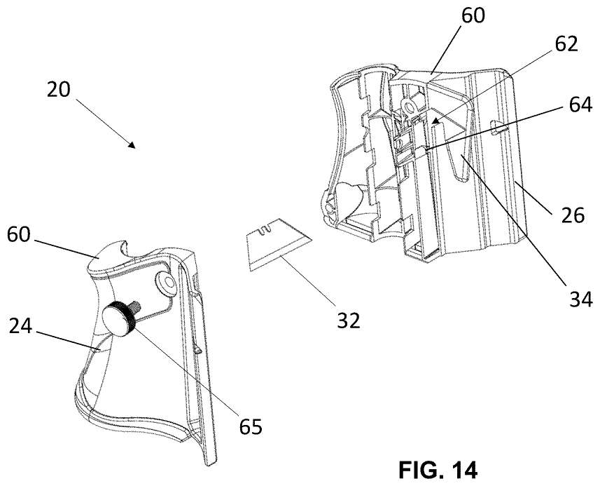

In this embodiment, one of the complementary components 60 can be adapted to hold the cutting element 32 therein, where connecting the complementary components together secures the cutting element in place (e.g., between the guiding wings 26). As seen in FIGS. 14 to 17, one of the complementary components 60 can include a recessed portion 62 defined therein which is shaped to substantially conform to the shape of the cutting element 32 (or vice-versa). The complementary component can further include security features, such as a hook 64 extending upwardly at least partially in front of the recessed portion 62 to assist in holding the cutting element within the recessed portion prior to connecting the complementary components together.

Similarly, one of the complementary components can be provided with the cutting guard 34. Alternatively, both complementary components can be provided with respective portions of the cutting guard 34, which can be assembled upon connecting the complementary components together.

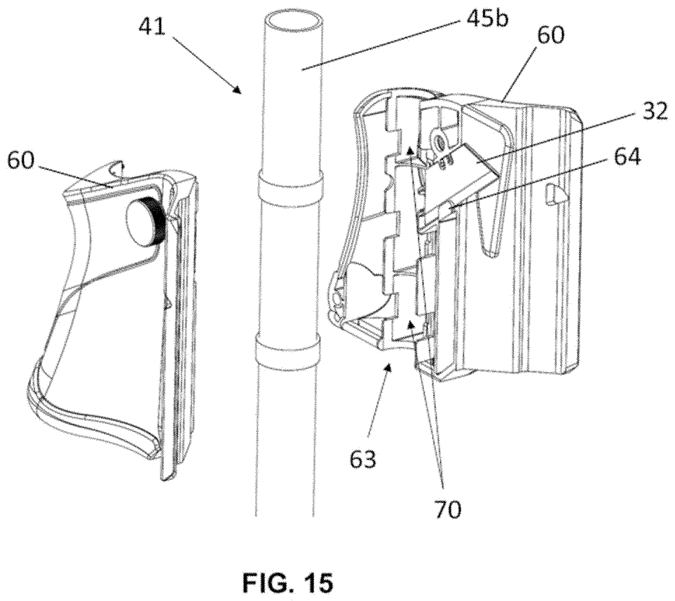

In this embodiment, the complementary components 60 are securable to one another about the second rod section 45b using a mechanical fastener, such as a thumb screw 65, although other connection methods can be used and are possible. As seen in FIGS. 15 to 17, the second rod section 45b can be provided with a locking mechanism configured to block movement of the second rod section 45b when coupled between the complementary components 60. In some embodiments, the locking mechanism can include one or more blockers 66, or blocking elements, mounted about the rod section 45b and being shaped and adapted to engage internal elements of the complementary components, such as complementarily shaped recesses 70, for example.

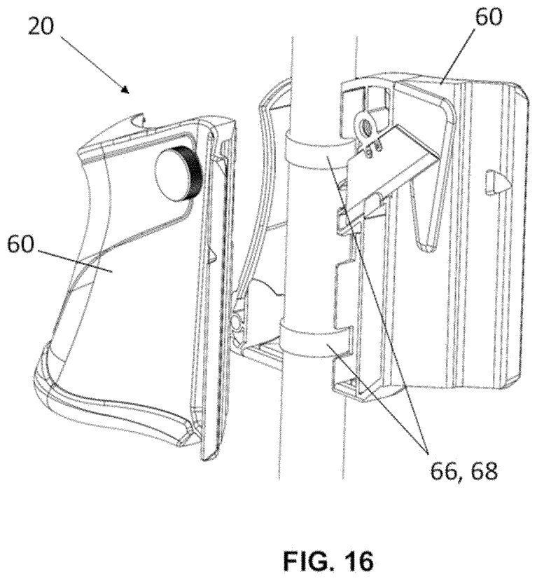

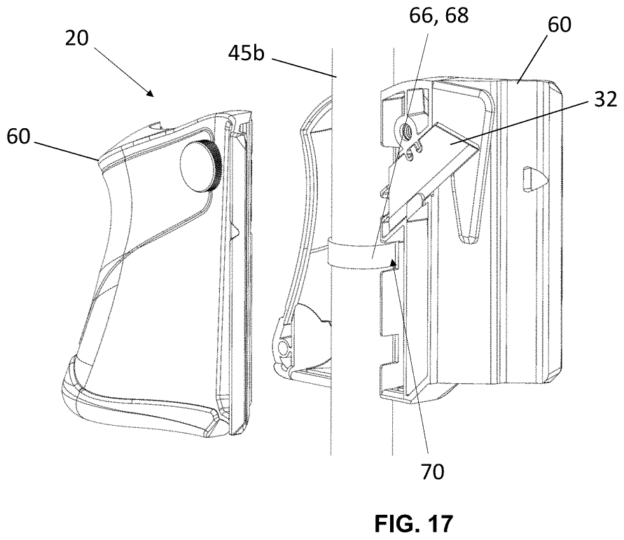

Referring more specifically to FIGS. 15 and 16, the adjustable rod 41 can be provided with a pair of blockers 66, which can include rings 68, spaced along the second rod section 45b. the rings 68 are adapted to engage respective recesses 70 defined in at least one of the complementary components 60. In other embodiments, such as the one illustrated in FIG. 17, the adjustable rod can include a single ring 68 configured to engage the corresponding recess 70. As described above, securing the complementary components 60 together about the second rod sections 45b positions and secures the rings 68 within the recesses 70, which prevents movement of the guide member 20 along the longitudinal axis of the second rod section (e.g., up or down along the rod section).

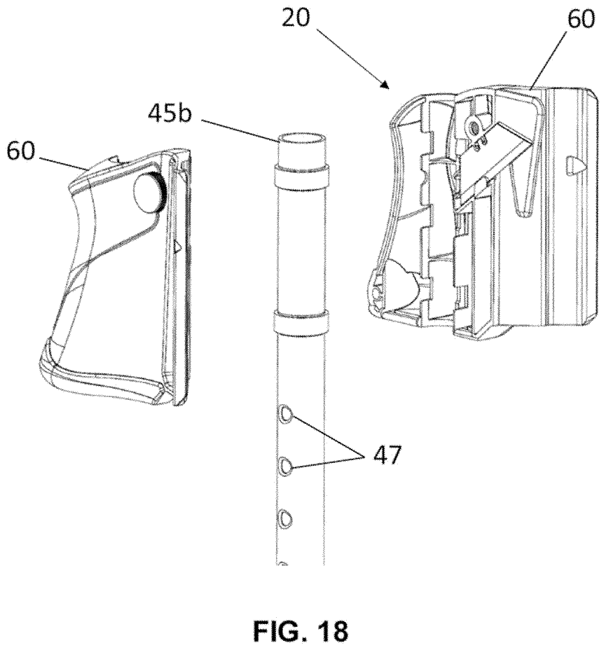

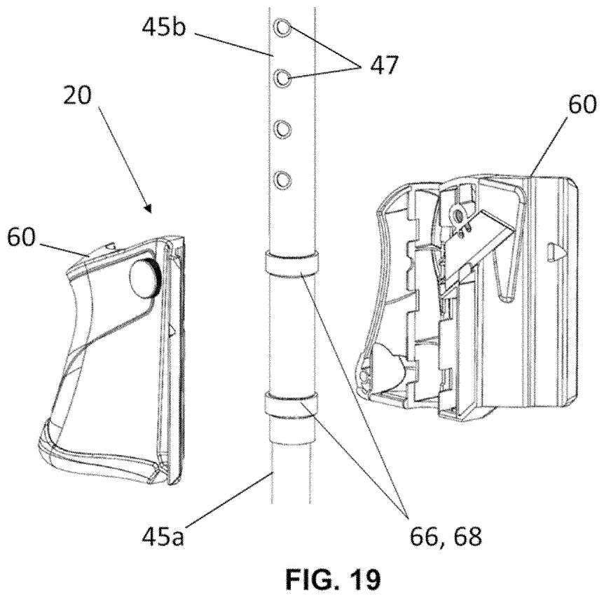

With reference to FIG. 18, the second rod section 45b can be positioned between the complementary components 60 in order to position the pin slots 47 below the guide member 20 (also seen in FIGS. 9 to 13). However, in some embodiments, and with reference to FIGS. 19 to 21, the second rod section 45b can be flipped “upside down” so as to position the pin slots 47 above the guide member 20. In these configurations, the first rod section 45a can still telescopically engage the second rod section 45b to define desired heights. It is noted that positioning the second rod section 45b in this manner permits defining smaller heights by engaging the retractable pin 46 with the pin slots 47 above the guide member 20. It is also noted that the first rod section 45a remains engageable with the second rod section 45b from below since the first rod section 45a includes the foot portion which is configured to contact the contact surface when performing cuts.

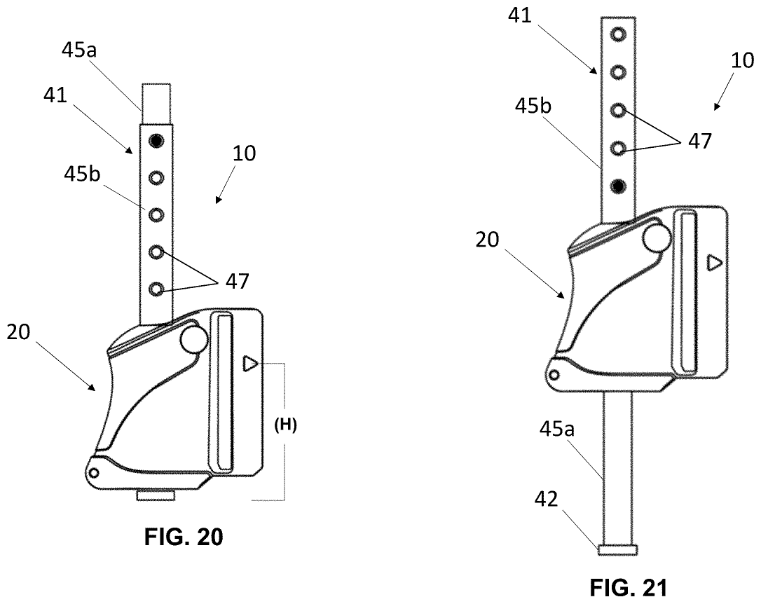

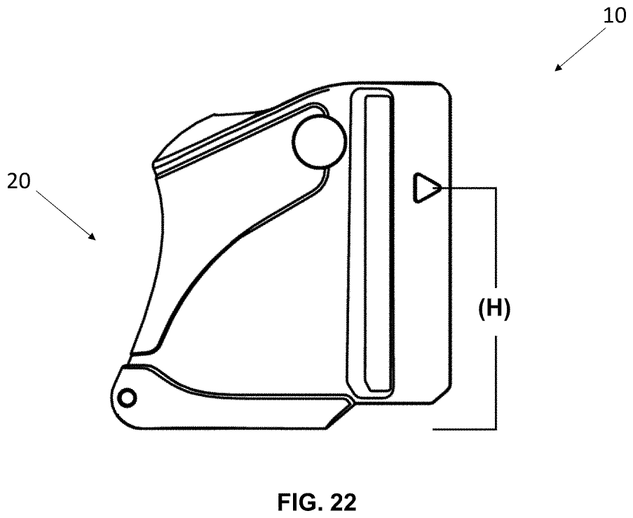

In some embodiments, the adjustable rod 41 can be adapted to define heights between about 4 inches (FIG. 20) and about 8 inches (FIG. 21), with intermediate pin slots 47 (e.g., the pin slots between the topmost and bottommost pin slots) being adapted to define any suitable heights between 4 and 8 inches, for example. It is noted that these heights (shown in FIGS. 20 and 21) can be smaller than the heights defined by the adjustable rod 41 when the pin slots 47 are positioned below the guide member 20 (shown in FIGS. 9 to 12). As seen in FIG. 22, it is possible to operate the cutting tool 10 without the adjustable rod by manipulating the guide member 20 by itself to cut along the corner of a box. In such embodiments, the height (H) is therefore defined between the position of the cutting element and the bottom of the guide member 20 and can correspond to a height of about 3 to 3.5 inches. It is thus appreciated that the cutting tool 10 can be adapted and adjusted to perform cuts ending at a desired height from the contact surface, and that the desired height can be adjusted between about 3 inches up to about 18 inches (e.g., in the illustrated embodiments). However, it is appreciated that other heights are possible and can be attained, such as by adding additional rod sections to increase the length of the adjustable rod 41 and/or by reducing the height of the guide member 20, for example.

It should thus be appreciated that various mechanisms and structures could be provided to adjust the height of the rod. Another example is that the rod could be slidable within the handle portion and securable at different positions, such that the lower section of the rod extending from the handle down to the ground can be changed by sliding the rod to a different position and re-securing it. In some embodiments, the guide member can have a through hole defined therein to enable the rod to extend above and below the guide member 20 (e.g., as seen in FIG. 21, among others).

In this embodiment, the guiding wings 26 are configured to position the cutting element 32 in a corner of a box, while the adjustable rod 41 controls the length of the cut. Therefore, it is noted that adjusting the length of the rod body 44 extending below the guide member 20 effectively adjusts the final height of the box after having performed the cuts in the corners thereof. In other words, the cutting element 32 cuts the corner of the box by running the guide member 20 downwardly along the corner until the foot portion 42 abuts the working surface.

In alternate embodiments, the guide member 20 can be slidably connected to the adjustable rod in a manner allowing movement along a length of the rod 41 during the cutting operation. The adjustable rod 41 can be provided with a stopping mechanism 50 configured to limit movement of the guide member 20 in at least one direction. Therefore, the cutting element 32 can be manipulated to cut along a predetermined length so as to cut the corner of a box at a corresponding desired height. The stopping mechanism 50 can include a protrusion 52 (e.g., a ping, a ring, etc.) along the rod body 44 configured to stop the downward movement of the guide member 20, and thus the cutting element 32, to prevent cutting the box too much, or too little. In this embodiment, the foot portion can include a greater surface area and remains in contact with a surface (e.g., a table, a counter, the floor, etc.) throughout the cutting operation. The greater surface area can increase stability of the tool, thereby enabling for faster and more reliable cuts to be performed.

It is noted that various other embodiments could be used for the cut-stopping system in order to set a predetermined height or distance of the desired cut and then cause the cutting tool to stop cutting once the predetermined height or distance has been reached. The rod embodiments could also be modified by using other structures that are not necessarily rod shaped.

Referring broadly to FIGS. 1 to 22, the cutting tool 10 can be made of any suitable material, such as metal and/or plastic for the various structural components (e.g., the base and central portions of the holder 30, the guiding wings 26, the adjustable rod 41, etc.) and rubber for ergonomic features such as portions of the handle 24 to improve grasp and below the foot portion 42 to prevent slipping of the adjustable rod 41. It is also appreciated that the cutting element 32 is a metallic razor blade, although other configurations are possible. In some embodiments, the plastic components can be 3D printed and subsequently assembled into the cutting tool 10. Alternatively, the components can be moulded or formed using any other suitable method.

As may now better be appreciated, the above-described cutting tool, and corresponding components, provide substantial improvements over known prior art in that, by virtue of its design and components, as explained herein, and the particular configuration of the cutting tool and/or component(s)/accessory(ies) thereof according to the present disclosure, it enables to carry out cutting a cardboard box along its corners in a single, sudden, confident and quick movement, and in a more efficient, more precise, more accurate, more reliable, more adjustable, more versatile, more adaptable, more impactful, more strategic, and/or more desirable manner (e.g., depending on the circumstances, and the intended results, etc.), compared to what is possible with respect to other known conventional cutting tools and/or methods. It is further appreciated that the cutting tool described above improves the security of the user by providing a cover to the cutting element, and positioning the cutting element between the guiding wings. In addition, the cut-stopping system prevents, or at least reduces the risk of unintentional movements and accidental cuts, among others, while also enabling the ability to perform faster and more accurate cuts.

In the embodiments described above, the same numerical references refer to similar elements. In addition, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

In addition, although the optional configurations as illustrated in the accompanying drawings comprise various components and although the optional configurations of the cutting tool as shown may consist of certain configurations as explained and illustrated herein, not all of these components and configurations are essential and thus should not be taken in their restrictive sense, i.e. should not be taken as to limit the scope of the present disclosure. It is to be understood that other suitable components and cooperations thereinbetween, as well as other suitable configurations may be used for the cutting tool, and corresponding parts, as briefly explained, and as can be easily inferred herefrom, without departing from the scope of the disclosure.

Several embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind.

In the present disclosure, an embodiment is an example or implementation of the perforation blade. The various appearances of “one embodiment,” “an embodiment” or “some embodiments” do not necessarily all refer to the same embodiments. Although various features may be described in the context of a single embodiment, the features may also be provided separately or in any suitable combination. Conversely, although the cutting tool may be described herein in the context of separate embodiments for clarity, it may also be implemented in a single embodiment. Reference in the specification to “some embodiments”, “an embodiment”, “one embodiment”, or “other embodiments”, means that a particular feature, structure, or characteristic described in connection with the embodiments is included in at least some embodiments, but not necessarily in all embodiments.

The present disclosure intends to cover and embrace all suitable changes in technology. The scope of the present disclosure is, therefore, described by the appended claims rather than by the foregoing description. The scope of the claims should not be limited by the implementations set forth in the examples, but should be given the broadest interpretation consistent with the description as a whole.

As used herein, the terms “coupled”, “coupling”, “attached”, “connected” or variants thereof as used herein can have several different meanings depending in the context in which these terms are used. For example, the terms coupled, coupling, connected or attached can have a mechanical connotation. For example, as used herein, the terms coupled, coupling or attached can indicate that two elements or devices are directly connected to one another or connected to one another through one or more intermediate elements or devices via a mechanical element depending on the particular context.

1. A cutting tool for cutting a corner of a cardboard box, the cutting tool comprising:
a guide member comprising:
a handle; and
a guide extending forwardly from the handle and comprising a pair of guiding wings adapted to engage the cardboard box to position the cutting tool relative to the corner;
a cutting element operatively connected to the guide and extending between the guiding wings, the cutting element being adapted to cut the corner of the box via a downward movement of the guide member along the corner of the box; and
a cut-stopping system connected to the guide member, the cut-stopping system being adapted to contact a working surface to block the downward movement of the guide member, thereby limiting the length of the cut.

2. The cutting tool of claim 1, wherein the cut-stopping system comprises an adjustable rod having a foot portion adapted to contact the working surface and a rod body extending upwardly from the foot portion, and wherein the guide member is removably coupled to the rod body.

3. The cutting tool of claim 2, wherein the rod body comprises a first rod section and a second rod section operatively coupled to one another, where at least one of the first and second rod section is movable relative to the other one of the first and second rod sections to adjust a length of the rod body.

4. The cutting tool of claim 3, wherein the first rod section is adapted to be inserted into the second rod section from below, and wherein the first rod section comprises a retractable pin and the second rod section comprises pin slots spaced along the second rod by a second rod distance, the pin slots being shaped and adapted for receiving the retractable pin and secure the first and second rod sections together to define the length of the rod body.

5. The cutting tool of claim 4, wherein the first rod section comprises a pair of retractable pins spaced along the first rod by a first rod distance greater than allowing only one of the pair of retractable pins to engage the pin slots.

6. The cutting tool of claim 4 or 5, wherein the guide member comprises a pair of complementary components connectable to one another about the rod body.

7. The cutting tool of claim 6, wherein the guide member is removably secured to the second rod section.

8. The cutting tool of claim 7, wherein the second rod section is provided with a blocking element along a length thereof, and wherein at least one of the complementary components is provided with a recess shaped and adapted to receive the blocking element when connecting the complementary components together about the rod body, the blocking element being adapted to block movement of the guide member relative to the second rod section when engaged in the recess.

9. The cutting tool of claim 8, wherein the blocking element is substantially symmetrical and is adapted to enable positioning the second rod section upside down between the complementary components.

10. The cutting tool of claim 8 or 9, wherein the blocking element comprises one or more rings secured to the second rod section.

11. The cutting tool of any one of claims 6 to 10, wherein the second rod section is adapted to be selectively positioned between the complementary components in a manner positioning the pin slots either below the guide member or above the guide member.

12. The cutting tool of any one of claims 6 to 11, wherein at least one of the complementary components comprises a recessed portion shaped and adapted to receive the cutting element, and wherein the cutting element is secured within the recessed portion upon connecting the complementary components together.

13. The cutting tool of any one of claims 6 to 12, wherein at least one of the complementary components comprises a cutting guard shaped and configured to at least partially surround the cutting element.

14. The cutting tool of claim 13, wherein the cutting guard comprises a guard tip extending downwardly from a forward end of the cutting guard, the guard tip extending vertically below the cutting element.

15. The cutting tool of any one of claims 6 to 14, wherein the complementary components are connectable to one another using at least one mechanical fastener.

16. The cutting tool according to any one of claims 1 to 15, wherein the pair of guiding wings extend from the handle in a manner defining an angle therebetween, each guiding wing comprising a box-engaging surface being shaped and configured to contact a corresponding side of the cardboard box when positioning the cutting tool in the corner.

17. The cutting tool according to claim 16, wherein the angle is generally 90 degrees.

18. The cutting tool according to claim 16 or 17, wherein the box-engaging surface comprises a recess extending along a height thereof, the recess being shaped and sized to be spaced away from the side of the cardboard box during operation of the cutting tool.

19. The cutting tool according to any one of claims 1 to 18, wherein the guiding wings are adapted to maintain the cutting element aligned with the corner of the box during the entire length of the cut.

20. A cutting tool for cutting a corner of a box, the cutting tool comprising:
a guide member comprising a pair of complementary components connectable to one another to define a pair of guiding wings adapted to engage the box and position the cutting tool relative to the corner, where connecting the complementary components together defines and internal chamber therebetween;
a cutting element secured and extending between the guiding wings, the cutting element being adapted to cut the corner of the box via a cutting motion of the guide member along the corner of the box; and
an adjustable rod comprising:
a locking mechanism proximate a first end of the adjustable rod and being configured to be secured within the internal chamber to prevent movement of the guide member relative to the adjustable rod; and
a cut-stopping system proximate a second end of the adjustable rod and being adapted to come into contact with a contact surface and block the cutting motion of the guide member.

21. A cutting tool for cutting a corner of a box, the cutting tool comprising:
a guide member comprising a pair of complementary components connectable to one another to define a guide adapted to engage the box and position the cutting tool relative to the corner, where connecting the complementary components together defines and internal chamber therebetween;
a cutting element secured and extending between the guiding wings, the cutting element being adapted to cut the corner of the box via a cutting motion of the guide member along the corner of the box; and
an adjustable rod comprising:
a first rod section comprising a cut-stopping system adapted to come into contact with a contact surface and block the cutting motion of the guide member; and
a second rod section comprising a locking mechanism configured to be secured within the internal chamber to prevent movement of the guide member relative to the adjustable rod, where the first and second rod sections are slidably connectable and selectively securable to one another to define a length of the adjustable rod.

22. A cutting tool for cutting a corner of a box, the cutting tool comprising:
a guide member comprising a pair of complementary components connectable to one another to define a guide adapted to engage the box and position the cutting tool relative to the corner, where connecting the complementary components together defines and internal chamber therebetween;
a cutting element secured and extending between the guiding wings, the cutting element being adapted to cut the corner of the box via a cutting motion of the guide member along the corner of the box; and
an adjustable rod comprising:
a first rod section comprising a cut-stopping system adapted to come into contact with a contact surface and block the cutting motion of the guide member; and
a second rod section comprising a first end at least partially securable within the internal chamber to prevent movement of the guide member relative to the second rod section, and a second end opposite the first end, the second rod section being adapted to be selectively positioned between the complementary components in a manner positioning the second end either below the guide member or above the guide member.

23. The cutting tool of claim 22, wherein the first and second rod sections are slidably connectable and selectively securable to one another to define a length of the adjustable rod.

24. The cutting tool of claim 22 or 23, wherein the first rod section is adapted to engage the end of the second rod section positioned below the guide member.

25. The cutting tool of any one of claims 22 to 24, wherein the first rod section comprises a retractable pin and the second rod section comprises pin slots shaped and adapted for receiving the retractable pin to at least partially secure the first and second rod sections together to define the length of the rod body.

26. The cutting tool of claim 25, wherein the first rod section comprises a pair of retractable pins spaced along a length thereof by a distance allowing only one of the pair of retractable pins to engage the pin slots.
